(19) United States
(12) Patent Application Publication
(10) Pub. No.: US 2017/0267216 A1
(43) Pub. Date: Sep. 21, 2017

(54) SCREEN WIPER BLADE FOR A VEHICLE

(71) Applicant: Valeo Systèmes d'Essuyage, Le Mesnil Saint Denis (FR)

(72) Inventors: Geoffrey Bayard, Le Mesnil Saint Denis (FR); Jean-Michel Jarasson, Le Mesnil Saint Denis (FR); Gérald Caillot, Le Mesnil Saint Denis (FR); Vincent Izabel, Le Mesnil Saint Denis (FR)

(73) Assignee: Valeo Systèmes d'Essuyage, Le Mesnil Saint Denis (FR)

(21) Appl. No.: 15/464,521

(22) Filed: Mar. 21, 2017

(30) Foreign Application Priority Data
Mar. 21, 2016 (FR) 1652402

(51) Int. Cl. B60S 1/48; B60S 1/38; B60S 1/52

(52) U.S. Cl. CPC B60S 1/488; B60S 1/52; B60S 1/3805

(57) ABSTRACT

Screen wiper blade of a vehicle, in particular a motor vehicle, comprising a heating electrical circuit, characterized in that said circuit comprises at least one bimetal strip thermostat configured to provide a thermal fuse function.

This invention relates to a screen wiper blade for a vehicle, in particular a motor vehicle, this wiper blade being of the type including an electrical heating circuit.

It is known that a screen wiper blade of a motor vehicle can be heated, in particular to device it in winter. In the case where this wiper blade is equipped with internal channels for distributing a screen washing liquid, heating the screen wiper blade can furthermore make it possible to heat the liquid before it is misted onto the windscreen of the vehicle, which facilitates de-icing of the windscreen and can thus make it possible to avoid using a manual ice scraper.

Typically, a screen wiper blade of the “flat wiper blade” type comprises a longitudinal body supporting a wiper strip, usually in rubber, which is designed to rub against the windscreen of the vehicle in order to evacuate water by taking it out of the field of view of the driver. The wiper blade furthermore includes at least one longitudinal vertebra, which imparts bending on the wiper strip so as to assist the application of this strip on the windscreen. The wiper blade is supported by an arm that is driven by a motor in a back and forth movement. The means of attaching the wiper blade to the arm generally comprise a connector, which is integral with the body, and an adapter, which is hinged on the body, and fastened to an end of the arm.

In the prior art, the means of heating a screen wiper blade generally comprise a heating electrical conductor.

It has already been proposed to equip the vertebra for bending a wiper blade with heating means, these heating means being presented in the form of a film, which is applied and bonded to the vertebra, and which includes a circuit or a track of a heating electrical conductor. In the prior art, the conductor of the circuit forms a loop whose ends are connected to terminals or a power supply.

For a top range vehicle, controlling and protecting the function of heating a screen wiper blade usually take place directly by means of the electronics and of the electrical circuit of the vehicle. This controlling necessitates specific upstream integration for the definition of the electrical architecture of the vehicle, and therefore generates a certain cost.

For medium or bottom range vehicles, some customers do not wish to modify their architecture and request integration of the protection directly in the heating wiper blade, so as not to affect the other functions of the vehicle in a deteriorated mode of the function (incorrect information, failure of the outside temperature or vehicle speed sensor, for example).

In a general manner, the heating function is triggered below an outside temperature of +5° C. in order to ensure overall de-icing of the wiper blade, either with distribution channels, means of attaching the wiper blade to the arm, or even the wiper strip in contact with the windscreen. In a deteriorated mode for example, a failing outside temperature or vehicle speed sensor—for example, the vehicle is stopped but the sensor says that the vehicle is moving), the effect would be permanent heating of the wiper blades beyond +5° C., potentially in high summer with ambient temperatures above +30° C., with a potential risk capable of causing a hot spot, a short-circuit, physical deterioration of the wiper blade and in the worst case, the start of a fire.

The invention proposes a simple, effective and affordable solution to this problem of the prior art.

The invention proposes a screen wiper blade of a vehicle, in particular a motor vehicle, comprising a heating electrical circuit, characterized in that said circuit comprises at least one bimetal strip thermostat configured to provide a thermal fuse function.

With a view to preserving the electrical and electronic circuit of the vehicle, to preventing deterioration of the wiper blade and hence of the wiping function, essential for the customer, the invention proposes to integrate, in the wiper blade or in a component of the wiper blade, a fuse function making it possible to avoid the aforementioned risks. In the case where this fuse function would be activated, the wiper blade would lose its heating function, which remains optional, and would retain its wiping function, which in itself is a legal requirement. This loss of function is temporary here due to the type of fuse used, namely a bimetal strip thermostat.

A bimetal strip thermostat comprises for example two plates, electrically conducting and having different coefficients of expansion. When the temperature of the plates is lower than a threshold temperature, the plates are in contact. The electrical circuit is therefore closed and the heating circuit functions. When the temperature rises, the plates expand and deform differently, hence moving sway from each other. When the plates reach the threshold temperature, the plates of the bimetal strip separate. The electrical circuit is therefore open and the heating circuit no longer functions. The bimetal strip thermostat acts as a switch of the electrical circuitry allowing the circulation of current to be switched off when the temperature of the plates reaches the threshold temperature.

This thermal protection can conceivably be used in two ways: either by directly heating the thermostat; the current one wishes to control passes directly into the thermostat; this is the case if the thermostat is placed in series on the heating circuit (heating wire or film, for example), or by indirectly heating the thermostat; this is the case if the thermostat is placed away from the heating circuit, for example on an electrical conductor or electric cable for powering the wiper blade.

The wiper blade according to the invention can comprise one or more of the following characteristics, taken in isolation from each other or combined with each other:
said at least one bimetal strip thermostat is situated at a longitudinal end of the wiper blade,
said at least one bimetal strip thermostat is situated in a zone of attachment of the wiper blade to a screen wiper blade arm; this type of attachment allows the cost of the protection to be limited in the event of replacement of the wiper blade because the bimetal strip thermostat can be placed on the cable or the electrical conductors powering the wiper blade heating circuits this solution being affordable,
this wiper blade being of the rocking lever type,
this wiper blade being of the flat type and including a longitudinal vertebra for bending, which is integral, substantially in its middle, with a mechanical connector for attachment to a screen wiper arm,
said at least one bimetal strip thermostat is situated at the mechanical connector,
said at least one bimetal strip thermostat is situated at at least one end piece, installed at a longitudinal end of said vertebra,
the wiper blade comprises a hydraulic connector configured to cooperate, for example by insertion, with said mechanical connector,
said at least one bimetal strip thermostat being situated at the hydraulic connector or on said hydraulic connector,
the wiper blade comprises an electrical connector configured to cooperate, for example by insertion, with said mechanical connector,
said at least one bimetal strip thermostat is situated at the electrical connector or on said electrical connector,
said at least one bimetal strip thermostat is connected to at least one electrical wire supplying said electrical connector,
said at least one bimetal strip thermostat is situated in or on a longitudinal casing or body of said wiper blade,
said at least one bimetal strip thermostat is associated with an indicator light configured to signal a state of this thermostat, and
the wiper blade comprises at least one ramp for distributing a fluid, in particular, a screen washing liquid.

The invention will be better understood, and other details, characteristics and advantages of the invention will appear on reading the following description, made as a non-limitative example and with reference to the attached drawings, in which:

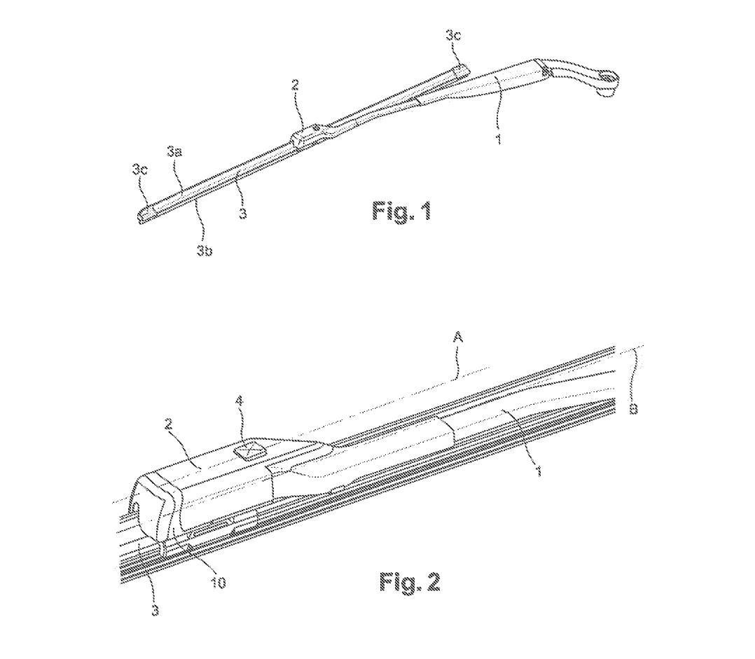

FIG. 1 is a diagrammatic view in perspective of a wiper system for a window of a motor vehicle;

FIG. 2 is a detailed view of FIG. 1, showing the attachment between the screen wiper blade and the driving arm;

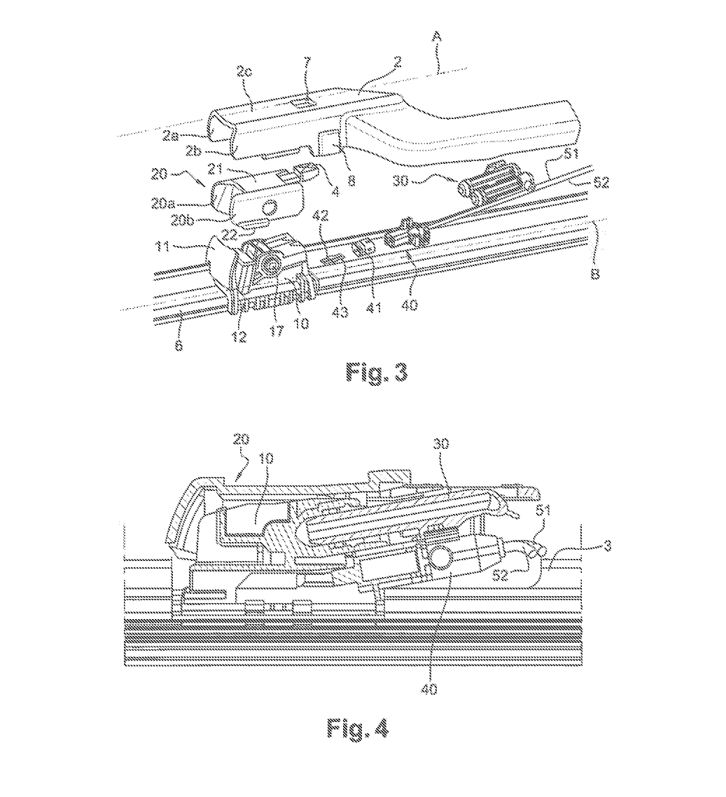

FIG. 3 is an exploded view of the attachment of FIG. 2;

FIG. 4 is a diagrammatic view in perspective and in longitudinal section of a part of the wiper blade of FIG. 3;

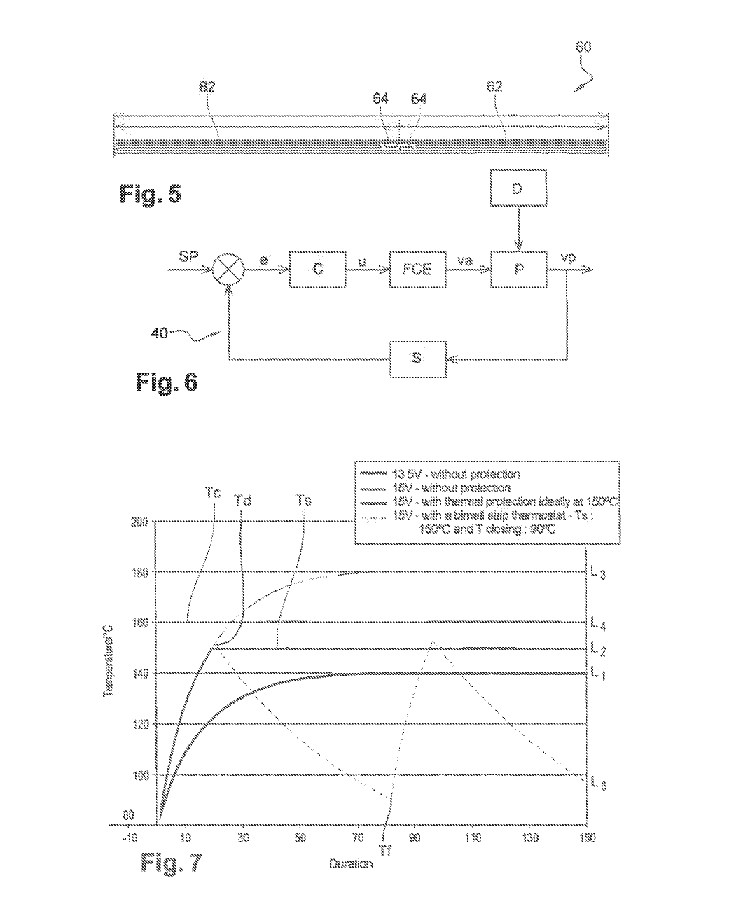

FIG. 5 is a diagrammatic view of a heating vertebra of the wiper blade;

FIG. 6 shows a control loop allowing control of a temperature of the wiper blade heating circuit;

FIG. 7 is a graph showing the temperature variation of the nesting circuit at different power supply voltages;

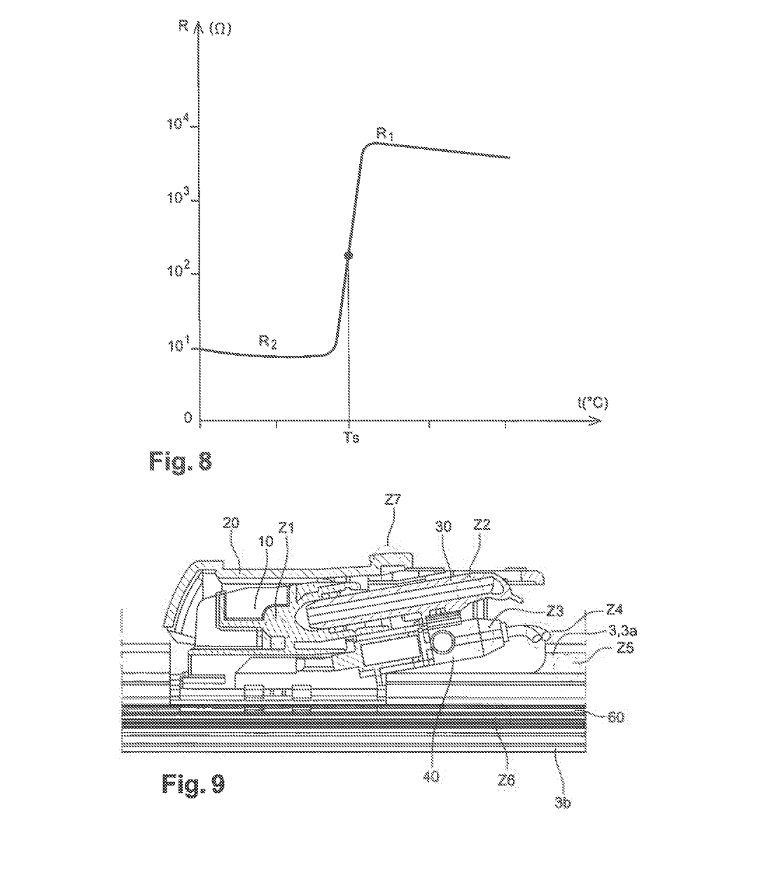

FIG. 8 is a graph showing the resistance variation of the bimetal strip thermostat as a function of temperature;

FIG. 9 is a view corresponding to FIG. 4 and illustrates embodiment variants of the invention;

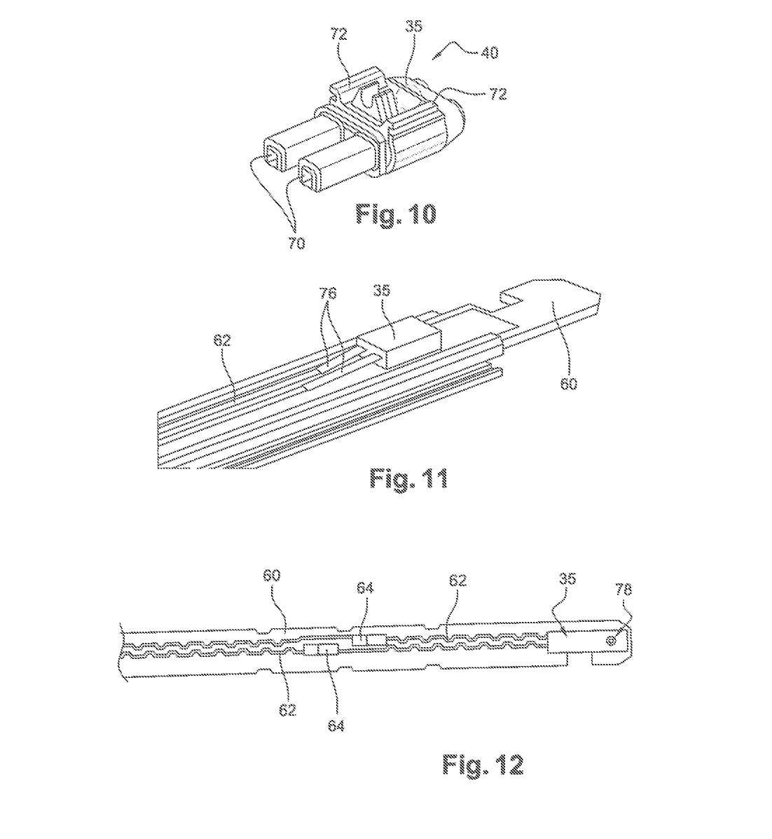

FIG. 10 is a diagrammatic view in perspective of an electrical or hydraulic connector of the wiper blade according to the invention;

FIGS. 11 and 12 are diagrammatic views in perspective of vertebrae, and illustrate embodiment variants of the invention.

It should be noted that the figures describe the invention in a detailed manner for implementing the invention, said figures of course being capable of better defining the invention if necessary.

In the description that follows, the designations longitudinal or lateral refer to the orientation of the screen wiper blade according to the invention. The longitudinal direction corresponds to the main axis of the wiper blade, in which it extends, while the lateral orientations correspond to intersecting lines, that is to say, that cross the longitudinal direction, substantially perpendicular to the longitudinal axis of the wiper blade in its plane of rotation. For longitudinal directions, the designations high or low are observed in relation to the securing point of the wiper blade on the arm, the designation inner corresponding to the part where the arm and half a wiper blade extend.

On referring to FIGS. 1 and 2, a wiper system is seen, consisting of an arm 1, prolonged at its outer end by a terminal piece 2, which is secured for example by a crimping on the inner side of the arm 1. The terminal piece 2 covers an adapter supporting the wiper blade 3 by means of a mechanical connector 10. The vocation of the adapter is to be inserted in the terminal piece 2 by a translation movement along a first longitudinal direction A of the terminal piece 2, to arrive in the position of use, otherwise called the functioning position, where it is positioned to stop against a cooperating shape given to the terminal piece 2. It is then reversibly secured there by means of a retractable locking button 4, which cooperates with an orifice made for this purpose in the upper part of the terminal piece. The wiper blade extends longitudinally along a second longitudinal direction marked B.

The wiper blade 3 here comprises a longitudinal body 3a, a wiper strip 3b, usually in rubber, and at least one vertebra, which imparts bending on the strip 3b so as to assist the application of this strip on the windscreen.

The body 3a of the wiper blade 3 includes an upper deflector designed to improve the functioning of the wiper blade, the purpose of this deflector being to improve the pressure of the wiper blade on the windscreen and hence the aerodynamic performance of the system.

The wiper blade 3 furthermore comprises end pieces 3c for suspending the strip 3c and the vertebra on the body. These end pieces 3c are situated at each longitudinal end of the body 3a. Each end piece 3c comprises a body having at least one aerodynamic surface and defining a receptacle for accommodating the strip 3c and the vertebra in the example shown.

The body 3a of the wiper blade is embodied here in two independent parts, which are placed substantially end to end and connected together by the mechanical connector 10.

By referring now to FIG. 3, the detail can be seen of the components providing the attachment of the wiper blade 3 to the arm 1.

The terminal piece 2 has an inverted U shape, where the opening of this U shape faces the glass pane. This terminal piece 2 comprises a base 2c at the upper part and two lateral branches 2a and 2b extending in the direction of the glass pane. An orifice 7 is made in the base 2c, in which the retractable locking button 4 from the adapter 20 is accommodated. The lower section of each lateral branch comprises an edge folded at 90° in the direction of the inner space defined by the base 2c and the branches 2a and 2b, the function of this edge being on one hand longitudinally to guide the insertion of the adapter 20 and on the other, to act as a stop in translation at corresponding stops placed on the adapter 20. On at least one of the lateral branches 2a or 2b of the terminal piece 2, a retaining means 8 is secured, whose function is to retain the electrical connector directly, or indirectly via a support 30. The retaining means 8 blocks a translation of the electrical connector 40 when withdrawing the wiper blade 3 to hold it in the inner space of the terminal piece 2, which will be described in detail later. Advantageously, a retaining means 8 is integrated on each of the lateral branches 2a and 2b, constituents of the terminal piece 2. In such a situation, the terminal piece 2 includes 2 retaining means 8 opposite each other.

The adapter 20 has a clevis shape, complementary to the inner space of the terminal piece 2, so as to be accommodated in the latter. Two lateral sides 20a and 20b are joined by a bridge 21 and each one comprises, at its free end, a ledge 22 folded towards the outside of the adapter. These ledges 22 form a stop of translation when they come to bear against the folded edges of the lateral branches of the terminal piece 2. This adapter 20 also comprises two holes made through the lateral aides 20a and 20b and having a merged axis, designed to act as an axis of rotation between the wiper blade 3 and the arm 1 so as to authorize a freedom in rotation between the arm 1 and the wiper blade 3 when the wiping system operates back and forth movements. This allows the wiper blade 3 to follow the curve of the glass pane to be wiped.

The mechanical connector 10 is integrated irremovably on the wiper blade 3 so as to provide transmission of the mechanical load coming from the arm 1 to the wiper blade 3. It has a substantially parallelepiped shape extending in the second longitudinal direction B of the wiper blade 3, with two lateral flanks from which two trunnions or shaft 1, extend laterally, whose functions, on one hand are to integrate the mechanical connector on the adapter 20, and on the other, to serve, by cooperating with the holes made in the lateral sides 20a and 20b of the adapter, as an axis for the rotation of the wiper blade 3 relative to the arm 1.

On the outer side, the mechanical connector has a side 11, called cap, which, in the first instance, closes the front part of the terminal piece 2 and acts as a screen for protecting the components contained inside this terminal piece 2, and in the second instance, ensures exterior finishing of good craftsmanship. The face opposite the cap 11 of the mechanical connector 10, called inner face, includes electrical connection orifices (not visible) able to accommodate the electrical connector 40. As a variant, the cap 11 could be integrated with the adapter 20.

This inner face of the mechanical connector 10 also comprises one hydraulic inlet orifice or orifices extended by internal channels for distributing screen washing liquid. These distribution channels (not shown on the figures) extend inside the mechanical connector 10 to lead to feed conduits 12 formed in the mechanical connector 10, and therefore to supply tubes 6 for misting liquid through the wiper blade. These tubes extend along the two edges of the wiper blade 3 so as to project screen washing liquid as the wiper blade moves away and as it returns. These characteristics relative to the projection of screen washing liquid are globally called device for misting screen washing liquid, in the case where the screen wiper blade would be connected to a system for projecting screen washing liquid.

The hydraulic inlet orifices delimit channels internal to the mechanical connector, the function of these channels also being to accommodate the support 30 so as to hold it in position in the mechanical connector 10.

The electrical input orifices delimit conduits internal to the mechanical connector 10, the function of these conduits being to accommodate the electrical connector 40 and to provide electrical connection between the electrical network and the wiper blade 3.

These internal conduits contain plugs 42 and 43 onto which sockets supported by the electrical connector 40 are fitted. This electrical connection supplies the electric power necessary to the functioning of the heating element integrated in the wiper blade.

The electrical connector 40 or the support 30 (which is connected to the connector 40) is held on the terminal piece 2 by means of the retaining means 8. In other words, the retaining means guarantees a mechanical link between the electrical connector 40 and the terminal piece 2 as a function of the position of the wiper blade 3 relative to the terminal piece 2, and more generally relative to the arm 1. This link between the electrical connector 40 and the terminal piece 2 is not isostatic. In fact, it authorizes a movement, in particular a rotation for reasons that will be described later.

This electrical connector 40 accommodates two electric cables 51 and 52 through which the electric current coming from the electrical network of the vehicle is routed. These cables 51 and 52 are brought together to form a loom, which extends in the inner space of the terminal piece 2 and below the arm.

The electrical connector 40 also accommodates a sealing device 41 threaded onto the body. This sealing device 41 provides sealing of the electrical link between the electrical connector 40 and the mechanical connector 10.

The wiper blade 3 includes a heating element, this heating element including a circuit or track of a heating electrical conductor and a support of this circuit.

The support of the circuit is the vertebra 60 or one of the vertebrae of the wiper blade in the example shown. A vertebra 60 is metal and has an elongated shape. A vertebra 60 usually has a substantially rectangular shape in section and comprises two substantially parallel flat surfaces, upper and lower respectively.

FIG. 5 shows an embodiment of a vertebra 60 for the wiper blade. The vertebra 60 has one of the aforementioned flat surfaces, which is covered by a circuit of a heating electrical conductor.

The conductor is usually in stainless steel or in alloy based on copper, nickel, aluminium etc. (cupro, brass etc.).

In the examples shown, the circuit comprises two loops 62 and two terminals 64 for supplying power to these loops. For this purpose, the two ends of each loop 62 are connected respectively to the two terminals 64. More precisely, the positive terminal is connected to a first end of each loop and the negative terminal is connected to the opposite end of each loop.

As a variant, each circuit can comprise a single loop. In this case, the positive terminal is connected to a loop that goes to one end of the heating circuit, then comes back and goes to the other end, and comes back to the negative terminal. In the aforementioned case of a heating circuit with two parallel loops, there is one loop at the bottom and one at the top, and each one is connected to the positive terminal and to the negative terminal.

The terminals 64 are situated away from the longitudinal ends of the vertebra, and in a substantially median zone of this vertebra. These terminals are situated here in a zone extending between approximately 50 and 60% of the length of the vertebra, measured from one longitudinal end of the latter (and hence between approximately 40 and 50%, measured from the opposite end of the vertebra).

This zone corresponds to the position of the screen wiper blade connector on the vertebra 60. In fact, the connector can comprise electrical connection means designed to make contact with the terminals 64 of the vertebra circuit in the installed position. As a variant, the connector can be centred on the vertebra while the electrical connection between the terminals and the connection means is off centre (for reasons of spatial requirement, for example).

Controlling the heating of the heating element can be achieved thanks to an electronic circuit with pulse width modulation (PWM), linked to a temperature sensor of the vehicle or a vehicle speed sensor. In the case where a sensor happens to give incorrect information (vehicle at 150 km/h whereas it is stopped, negative outside temperature in high summer, etc.), the PWM could activate an inappropriate voltage (16V instead of a reduced voltage on stopping the vehicle, for example), which would result in a very significant temperature rise.

The loops 62 are connected in series to a current controller, which controls the loop temperature. The current controller comprises a bimetal strip thermostat calibrated to be activated at a predetermined threshold temperature Ts (see FIG. 7). The bimetal strip thermostat makes it possible to put in place a closed loop 40 for controlling the temperature of the loops 62. FIG. 6 shows this control loop 40 in a diagrammatic way.

A closed control loop usually comprises a controller C, seeking to hold a variable vp of a method P at a predetermined set value SP (for Set Point). The value of the variable vp of the method is measured by a sensor S, then compared with the set point SP. The difference between these two values is called error e. As a function of this error, the controller C sends a command a to a final control element (FCE), which will change an adjustment variable va. This adjustment variable va is inserted in the method P. Moreover, the method P is subject to disturbances D from the outside environment. The new value of the variable vp of the method is measured by the sensor S and sent to the controller C.

In the loop 40 for controlling the temperature, the controller C comprises the current controller. The method P comprises heating the loops 62. The method variable comprises the temperature T of the loops 62.

The bimetal strip thermostat comprises for example two plates (not shown), electrically conducting and having different coefficients of expansion. Thus, when the temperature of the loops 62 is lower than the threshold temperature Ts, the plates are in contact. The electrical circuit is therefore closed and the heating circuit functions. When the temperature rises, the plates expand and deform differently, thus moving away from each other. Thus, when the loops 62 reach the threshold temperature Ts, the plates of the bimetal strip separate. The electrical circuit is therefore open and the heating circuit no longer functions.

The bimetal strip thermostat acts as an electrical circuit breaker, allowing the circulation of current to be switched off when the temperature of the loops 62 reaches the threshold temperature Ts.

In the control loop 40, the bimetal strip thermostat is used as a controller C and as a sensor S. The variable vp of the method comprises the temperature T of the loops. This measured value is subtracted from the set point SP, which comprises the first temperature threshold Ts1. If the difference, that is to say, the error e, between these two values 25 is greater than or equal to zero, then the loops 62 risk exceeding the operating temperature limits of the materials they are made in, even reaching their melting point. In this case, the command u of the bimetal strip thermostat comprises opening the electrical circuit. The final control element FCE comprises for example the plates of the bimetal strip thermostat. The adjustment variable va comprises the value of the electric current, in this case this value is nil. The loops 62 are no longer powered and their temperature T drops.

In this control loop 40, the disturbances D comprise the ambient temperature, which varies according to the temperature outside the vehicle and according to whether the latter is stopped or moving.

FIG. 7 illustrates the temperature regulation of the loops 62 by means of a graph of variation of the temperature T (ordinate axis) of the loops 62 over time t (abscissa axis) for different power supply voltages.

On this figure, a first curve L1 represents the variation of the temperature T of the loops 62 powered with a voltage of 13.5V, a second curve L2 that of the loops 62 powered with a voltage of 15V, a third curve L3 that of the loops 62 powered with a voltage of 15V. In these first three arrangements, the heating device 21 does not comprise a current controller of the bimetal strip thermostat type.

FIG. 7 also shows a fourth horizontal curve L4 representing a critical operating temperature Tc of the loops 62. Beyond this temperature, the loops 62 can deteriorate. As an example, this critical temperature Tc is 160° C.

The curves L1 and L3 have the same profile: in a first instance, a rapid temperature rise is observed. This temperature rise corresponds to starting the heating circuit functioning or starting the vehicle. The temperature then stabilizes and tends towards a constant value.

The stabilized temperature of the curves depends on the voltage powering the loops 62. The higher the power supply voltage, and the greater the power released, and hence the higher the stabilized temperature. According to this example, the power supply voltages of 13.5V and 15V result respectively in stabilized temperatures of 140° C. and 180° C. The curve L3 therefore exceeds the critical temperature Tc of the loops 62.

The curve L2 shows a plateau at temperature Ts because the heating circuit is equipped with a thermal protection at 150° C.

Finally, FIG. 7 shows a fifth curve L5 representing the temperature variation of loops 62 powered with a voltage of 15V when the heating circuit comprises a current controller 35 of the bimetal strip thermostat type. As an example, a maximum temperature of 150° C. is desired for the loops 62. The temperature Ts of the bimetal strip thermostat is therefore 150° C., that is to say, slightly below the critical temperature Tc, which makes it possible to integrate a safety margin as a function of the tolerances of the bimetal strip thermostat.

The temperature Ts, or Td for activation temperature (150° C. here), corresponds to the opening temperature of the circuit, that is to say, of separation of the plates of the bimetal strip thermostat, and to the loss of temperature. The temperature Tf for the closing temperature (90° C. here) corresponds to the circuit closing, that is to say to the convergence and contact of the plates of the thermostat, and hence to the re-activation of heating, Td>Tf. The curve 15 has a sawtooth shape.

Thanks to the bimetal strip thermostat, the temperature of the loops 62 therefore remains lower than the critical operating temperature Tc.

Experimental observations have shown that the resistance of the loops 62 varies with the temperature.

It is said that the resistance of the loops 62 shows a thermal deviation. The characteristics of this thermal deviation (profile of the curve representing resistance as a function of temperature) depend on the manufacturing material of the loops 62, on the voltage and on the power supply current.

Given that the dissipated heat depends on the resistance of the loops 62, it is understood that the dissipated heat is not stable vis-â-vis the temperature.

Moreover, the variation of resistance of the loops 62 causes a variation of the current circulating in the electrical circuit of the heating circuit.

In the present case, the behaviour of the bimetal strip thermostat is advantageously similar to that of a thermistor with a positive temperature coefficient (PTC), whose resistance increases significantly with temperature in a limited temperature range, but reduces outside this zone. FIG. 8 represents the variation of the resistance of the bimetal strip thermostat as a function of temperature. Three resistance zones can be distinguished on this figure: a first zone with low temperatures used to improve the stability of the current travelling the loops, a second zone around the threshold temperature Ts, which is used to provide the function of a resettable or reversible fuse, and a third zone of high temperatures beyond the threshold temperature.

The behaviour of the bimetal strip thermostat in the first zone can be used to improve the stability of the current that travels the loops 62. Its behaviour in the second zone can make it possible to switch off the circulation of current in the loops 62.

In fact, the thermostat has a threshold temperature beyond which its resistance increases significantly. In the example of FIG. 8, the resistance increases from 10.0 Ω to approximately 10000.0 Ω over a temperature range going from 70° C. to 100° C. The thermostat is no longer conducting and the current circulating in the loops 62 then tends towards a nil value. The current controller therefore acts as a switch. When the current no longer circulates in the loops 62, these no longer release heat and their temperature therefore drops. As soon as the temperature is lower than the second temperature threshold Ts, the resistance of the thermostat is low enough for it to resume conducting. The current therefore starts to circulate again in the loops 62, which start to heat again. Advantageously, the threshold temperature is lower than the critical temperature Tc of the loops 62, for example, the threshold temperature is 150° C.

According to another variant, the behaviour of the bimetal strip thermostat in the first zone and in the second zone makes it possible to control the circulating current, on one hand by stabilizing it and on the other by switching it off as a function of the temperature of the loops 62.

According to a variant, the bimetal strip thermostat has several threshold temperatures. For example, the bimetal strip thermostat can be configured to open the electrical circuit at 150° C. and to close it again at 130° C.

The bimetal strip thermostat connected to the loops 62 therefore controls the current passing through them as a function of the loop temperature, by acting as a temperature controller.

This temperature controller therefore makes it possible to improve the robustness of the heating circuit for the loops 62. Moreover, a bimetal strip thermostat is a low cost item.

As illustrated on FIG. 9, the bimetal strip thermostat can be placed:
in a zone Z1 at the mechanical connector 10, for example in or on the mechanical connector,
in a zone Z2 at the hydraulic connector 30, for example in or on the hydraulic connector,
in a zone Z3 at the electrical connector 40, for example in or on the electrical connector,
in a zone Z4 at the electric wires 51, 52,
in a zone Z5 at the body 3a of the wiper blade, for example on or inside this body 3a,
in a zone Z6 at the vertebra 60, for example on the vertebra, near the mechanical connector 10 or away from it, even
in a zone Z7 at the adapter 20 or the terminal piece 2.

When heating is activated, the heat flux rises. The presence of a bimetal strip thermostat in one of the aforementioned zones makes it possible to cut off the heating power supply in the event of an excessive circuit temperature. The bimetal strip thermostat thus acts as a thermal fuse.

FIG. 10 is an embodiment of an electrical connector 40 supporting a bimetal strip thermostat 35. The connector includes a body supporting electrical connection plugs 70 configured to be connected by insertion to complementary plugs of the mechanical connector 10 of the wiper blade. The connector comprises means 72 for securing to the hydraulic connector 30 of the wiper blade. These securing means 72 are supported by the body 22 of the connector in the example shown.

The bimetal strip thermostat 35 can also be supported by the body of the connector 30, 40.

FIGS. 11 and 12 illustrate embodiment variants in which the bimetal strip thermostat 35 is situated on the vertebra 60, and more precisely in the vicinity of a longitudinal end of this vertebra.

The bimetal strip thermostat 35 is situated on the surface, upper here, of the vertebra 60 on which the heating circuit is situated, that is to say, on which the loops 62 are situated. The plates of the thermostat 35 are connected to two portions of a loop 62 by means of conductors 76 or suitable wires, soldered for example to the plates and to the loop portions. These conductors can pass through openings made in the heating film supported by the vertebra and integrating the heating circuit. The assembly including the bimetal strip thermostat 35 and the conductors 76 for connection to the loop 62 can be encapsulated or overmouided to protect them.

The embodiment variant of FIG. 12 differs from that of FIG. 11 in that the bimetal strip thermostat 35 is associated with an indicator light 78, which allows a user to be informed of the state of the bimetal strip thermostat. For example, when the plates of the thermostat are electrically connected together, the heating circuit is operational and the indicator light 78 can be illuminated. When the plates of the thermostat are away from each other and hence not electrically connected, the heating circuit is not operational and the indicator light 78 can be extinguished.

The indicator light is preferably situated at the thermostat and hence in one of the aforementioned zones Z1 to Z7.

1. A screen wiper blade of a motor vehicle, comprising:

a healing electrical circuit comprising at least one bimetal strip thermostat configured to provide a thermal fuse function.

2. The wiper blade according to claim 1, wherein said at least one bimetal strip thermostat is situated at a longitudinal end of the wiper blade.

3. The wiper blade according to claim 1, wherein said at least one bimetal strip thermostat is situated in a zone of attachment of the wiper blade to a screen wiper blade arm.

4. The wiper blade according to claim 1, the wiper blade being of a rocking lever type.

5. The wiper blade according to claim 1, the wiper blade being of a flat type and including a longitudinal vertebra for bending, which is integral, substantially in middle of the vertebra, with a mechanical connector for attachment to a screen wiper arm.

6. The wiper blade according to claim 5, wherein said at least one bimetal strip thermostat is situated at the mechanical connector.

7. The wiper blade according to claim 5, wherein said at least one bimetal strip thermostat is situated at at least one end piece, installed at a longitudinal end of said vertebra.

8. The wiper blade according to claim 1, further comprising: a hydraulic connector configured to cooperate by insertion with said mechanical connector.

9. The wiper blade according to claim 8, wherein said at least one bimetal strip thermostat is situated at the hydraulic connector or on said hydraulic connector.

10. The wiper blade according to claim 8, further comprising: an electrical connector configured to cooperate by insertion with said mechanical connector.

11. The wiper blade according to claim 10, wherein said at least one bimetal strip thermostat is situated at the electrical connector or on said electrical connector.

12. The wiper blade according to claim 11, wherein said at least one bimetal strip thermostat is connected to at least one electrical wire supplying said electrical connector.

13. The wiper blade according to claim 5, wherein said at least one bimetal strip thermostat is situated in or on a longitudinal casing or body of said wiper blade.

14. The wiper blade according to claim 1, wherein said at least one bimetal strip thermostat is associated with an indicator light configured to signal a state of this thermostat.

15. The wiper blade according to claim 1, further comprising at least one ramp for distributing a screen washing liquid.
